(19) United States
(12) Patent Application Publication
(10) Pub. No.: US 2026/0138209 A1
(43) Pub. Date: May 21, 2026

(54) LASER OPTICS AND METHOD FOR LASER CUTTING BY MEANS OF AN ANNULAR INTENSITY DISTRIBUTION AND CORRESPONDINGLY DESIGNED LASER SYSTEM

(71) Applicant: TRUMPF Laser SE, Schramberg (DE)

(72) Inventors: Daniel Flamm, Ludwigsburg (DE); Nicolai Speker, Pleidelsheim (DE); Tim Hesse, Ditzingen (DE)

(21) Appl. No.: 19/372,332

(22) Filed: Oct. 29, 2025

Related U.S. Application Data
(63) Continuation of application No. PCT/EP2024/060595, filed on Apr. 18, 2024.

(30) Foreign Application Priority Data
May 2, 2023 (DE) 10 2023 111 329.1

(51) Int. Cl. B23K 26/064; B23K 26/38

(52) U.S. Cl. CPC B23K 26/064; B23K 26/38

(57) ABSTRACT

An optical system for a laser system for laser cutting includes a light guide for simultaneously coaxially transporting a first laser beam as a single-mode or quasi-single-mode laser beam and a second laser beam as a multi-mode laser beam, and an optical device arranged in a beam path of the first laser beam downstream of the light guide. The optical device is configured to impose a phase singularity and/or a polarization singularity on the first laser beam for generating an annular intensity distribution of the first laser beam with a central intensity minimum on an optical axis of the optical system.

### CROSS REFERENCE TO RELATED APPLICATIONS

This application is a continuation of International Application No. PCT/EP2024/060595 (WO 2024/227625A1 ), filed on Apr. 18, 2024, and claims benefit to German Patent Application No. DE 10 2023 111 329.1, filed on May 2, 2023. The aforementioned applications are hereby incorporated by reference herein.

### FIELD

Embodiments of the present invention relate to the field of laser technology, in particular to optics for a laser system intended for laser cutting. Embodiments of the invention further relate to such a laser system and to a method for machining, in particular cutting, a workpiece therewith.

### BACKGROUND

Lasers offer a wide range of useful possibilities for non-contact material machining, such as material removal or cutting a workpiece, or the like. Material can be melted and/or evaporated by the action of laser light, which can be used to create a cutting gap by guiding a laser beam over a workpiece, for example. The cutting behavior and/or properties of the cutting gap or a resulting cut edge of the remaining material can be influenced by adapting the laser system and the laser light.

For example, WO 2019/150071 A1 describes a device for laser machining a material. This device comprises a squeezing mechanism for squeezing together a periodically structured surface and an optical fiber. This allows a first optical mode and a second optical mode of laser radiation propagating in the optical fiber to be coupled together. The resulting laser light is intended to enable material machining in which the disadvantages or undesirable effects known from other laser-based material machining methods are reduced.

A similar approach is described in WO 2019/150070 A1. The latter describes a device for laser machining a material which comprises a laser, an optical fiber, and a coupler. The optical fiber is embodied in such a way that laser radiation can propagate therein in a first optical mode, a second optical mode, and a third optical mode, wherein the mode order of the third optical mode is the highest and the mode order of the first optical mode is the lowest. The coupler is configured to convert laser radiation propagating in the first optical mode into laser radiation propagating in the second optical mode. Furthermore, the coupler is configured to convert laser radiation propagating in the second optical mode into laser radiation propagating in the third optical mode. This too is intended to enable laser-based material machining that reduces known disadvantages and undesirable effects.

Despite the various known approaches to optimizing laser-based material machining, it has not hitherto been possible reliably to achieve an optimal result, for example with regard to a precise cutting gap geometry shaped as desired and/or with regard to thermal effects due to a temperature gradient between the material exposed to the laser light and the material surrounding it and/or the like.

### SUMMARY

Embodiments of the present invention provide an optical system for laser cutting. The optical system includes a light guide for simultaneously coaxially transporting a first laser beam as a single-mode or quasi-single-mode laser beam and a second laser beam as a multi-mode laser beam, and an optical device arranged in a beam path of the first laser beam downstream of the light guide. The optical device is configured to impose a phase singularity and/or a polarization singularity on the first laser beam for generating an annular intensity distribution of the first laser beam with a central intensity minimum on an optical axis of the optical system.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a partially schematic view of a laser system for cutting a workpiece using a ring-in-ring laser intensity distribution according to some embodiments; and

FIG. 2 shows a cross-sectional view of a corresponding simulated ring-in-ring laser intensity distribution according to some embodiments.

### DETAILED DESCRIPTION

Embodiments of the present invention can enable improved cutting performance and cutting gap quality in laser cutting.

The optics or optical system according to embodiments of the invention can be used advantageously in particular in a laser system for laser cutting workpieces or materials. However, other use cases may also be possible. Optics in the present sense can be understood in particular as an arrangement or combination of a plurality of components or parts for transporting, guiding, and influencing or shaping or conditioning light, in particular laser light or at least one laser beam. The optics according to embodiments of the invention comprise a light guide for simultaneously coaxially transporting, i.e., guiding or directing, a first laser beam as a single-mode or quasi-single-mode laser beam and a second laser beam as a multi-mode laser beam. In other words, the light guide is designed, for example, to transport a first component, corresponding to the first laser beam, of light coupled into the light guide on the input side in the basic mode or at least close to or largely in the basic mode, and a second component, corresponding to the second laser beam, of light coupled into the light guide on the input side further away from the basic mode, in a plurality of different modes. In other words, the first laser beam can have a smaller beam propagation ratio M², i.e., a greater or higher beam quality, than the second laser beam. The light guide can in particular be or comprise an optical waveguide or a light guide cable, i.e., an optical fiber or glass fiber. The laser beams can, for example, be guided in the light guide in completely or partly overlapping manner or separately from one another. The light guide can, for example, have a light guiding area for both laser beams, into which the already different laser beams can be coupled on the input side. Likewise, the light guide can, for example, have a plurality of light guiding areas. Thus, the first laser beam can then, for example, be guided only or mainly in a first light guiding area of the light guide, while the second laser beam can, for example, be guided only or mainly in another, second light guiding area or, for example, partly in the first light guiding area and partly in the second light guiding area. The light guiding areas can, for example, be directly adjacent to one another or separated or spaced apart by “cladding”. This is explained in more detail elsewhere. The thickness of this optionally provided cladding in the radial direction can be selected, for example, depending on the embodiment or depending on the requirements in the individual case.

Furthermore, the optics according to embodiments of the invention comprise an optical device for imposing a phase singularity and/or a polarization singularity on the first laser beam, i.e., on the single-mode or quasi-single-mode component of the light guided in the light guide or exiting the light guide on the output side. This optical device is thus configured or embodied to generate an annular intensity distribution of the first laser beam with a central intensity minimum on the optical axis of the optics. In other words, this optical device can thus convert, for example, an at least substantially Gaussian intensity distribution of the first laser beam into an annular intensity distribution. There are various ways of achieving this effect, and accordingly, various ways of specifically embodying the optical device, which are explained in more detail elsewhere. For example, the optical device may be or comprise a spiral phase plate and/or a spatial light modulator, such as, for example, a liquid crystal display or a DMD (digital micromirror device) for imposing the phase singularity and/or an S-waveplate for imposing the polarization singularity.

The correspondingly imposed phase or polarization singularity can also be checked by measurement, depending on the embodiment, for example by means of an interferometer or by means of a liquid crystal display in combination with a camera or by means of a rotating polarization filter or the like.

In the optics according to embodiments of the invention, the optical device is arranged in the intended light or beam path of at least the first laser beam. Along the longitudinal direction of this beam path, i.e., viewed in or along the intended beam propagation direction of the first laser beam in the optics or through the optics, the optical device is arranged downstream of the light guide. The optical device can therefore be arranged directly at an output end of the light guide, for example by slipping or splicing on or the like, or can be arranged at a distance from the output end of the light guide, such that the first laser beam transported in the light guide can exit from the light guide and then enter the optical device or irradiate through it. Depending on the embodiment, the optical device can be or comprise a single optically active element or component or an arrangement or combination of several components.

The optical device can equally be arranged in the beam path of the second laser beam, i.e., be irradiated thereby during operation. In practice, however, only the single-mode or quasi-single-mode component of the laser light irradiating the optical device is significantly influenced by the optical device. Thus, the phase and/or polarization singularity is imposed on the first laser beam by the optical device and the annular intensity distribution is generated thereby, while the second laser beam can irradiate through the optical device at least substantially unchanged or unaffected and can thus retain its original intensity distribution, i.e., that imparted upstream of the optical device, and can therefore also exhibit it downstream of the optical device.

The first laser beam can here be used for the actual cutting or melting of the respective material exposed to the laser beam. The actual cutting gap can thus be formed using the first laser beam. The first laser beam can be optimized particularly effectively and purposefully for this task, here for example by appropriately embodying or adapting the optical device for a particular situation or use case, for example the material to be cut.

At the same time, the second laser beam can be available or used for other tasks or effects. For example, the second laser beam can strike the respective workpiece or material also or only outside the actual cutting gap or at least be substantially absorbed in the entry area of the cutting gap. This makes it possible, for example, to round (off) the otherwise sharp-edged geometry of the upper, i.e., entry-side, cutting edge of the cutting gap which arises for example when the first laser beam is used alone. Such rounding can be particularly favorable to flow and thus, for example, enable more effective or efficient removal of molten or evaporated material from the cutting gap. In other words, the second laser beam can be used to shape the upper area of the cutting gap into a kind of inlet funnel when viewed in cross-section. In addition, by irradiating an area surrounding the actual cutting gap with the second laser beam, a temperature gradient in the respective workpiece or material can be flattened or adjusted. This can prevent or reduce corresponding undesirable thermal effects or stresses or the like.

Due to the joint coaxial guidance of the laser beams in the light guide, a reliable and consistent overlap or spatial relationship between the first laser beam and the second laser beam is always readily achieved. However, since, unlike the first laser beam, the second laser beam is a multi-mode laser beam, the optics can enable different or selective influencing of the two laser beams. This means that, despite the superimposed or coaxial or concentric arrangement or guidance of the two laser beams, different individual intensity distributions of the two laser beams can ultimately be obtained. This enables particularly simple and flexible adaptation to different requirements or use cases.

Furthermore, it has been shown that, with the annular intensity distribution of the first laser beam generated by the optical device, i.e., by imposing the phase and/or polarization singularity, said annular intensity distribution or the central intensity minimum thereof is not only present in the central focus point, but can propagate, i.e., be maintained, over more than one Rayleigh length in the longitudinal direction, i.e., when viewed in the light or beam propagation direction along the beam path. In particular, the annular shape can propagate or be maintained starting from the central focus point in the positive and negative longitudinal direction or beam propagation direction in each case for at least one Rayleigh length, i.e., over a total of at least two Rayleigh lengths. Thus, depending on the use case, the annular intensity distribution or the central intensity minimum thereof can be achieved or maintained over a length that may be in the range of the thickness of the workpiece or material to be cut. This is typically not the case with previous approaches to generating or using an annular intensity distribution of a cutting laser beam and can represent a significant advantage in practice. Embodiments of the present invention then make it possible to achieve particularly homogeneous, i.e., constant, absorbed intensities on the absorption front - within narrower limits than with previous approaches. This makes it possible, for example, to improve the burr-free nature of the resulting cutting gap or a resulting cutting edge when laser cutting sheet metal, especially at high feed rates. Thus, embodiments of the present invention simultaneously enable a particularly high cutting gap quality and a particularly high feed rate, i.e., a particularly high cutting performance.

In addition, embodiments of the present invention offer the possibility of targeted shaping of the cutting gap at depth or in the lower area, i.e., in the exit area. The lower area or exit area here is the area of the cutting gap that is located on a side of the respective workpiece or material facing away from the optics during operation. Embodiments of the present invention can therefore provide a further degree of freedom for shaping the cutting gap by appropriate parameterization or adaptation of the first laser beam by means of the correspondingly designed optical device. This means, for example, that the area of the cutting gap that lies below the rounding optionally created on the input side by the second laser beam can be purposefully adapted or shaped.

The optics can also have or comprise further components, such as, for example, collimation optics, i.e., partial optics for collimating the laser light emerging from the light guide, and/or focusing optics, i.e., partial optics for focusing the - optionally collimated - laser light into a focus point or focus area or onto the workpiece or material in each case to be cut or machined, and/or an output-side or surrounding protective glass and/or an adjusting device for setting or adapting the optics, for example by moving at least one optical component along the optical axis, i.e., in the light or beam propagation of the laser beam, and/or perpendicular thereto, and/or corresponding holders for fixing said components and/or a housing surrounding said components and/or the like.

In one possible embodiment of the present invention, the light guide is configured or designed to guide the first laser beam with a beam propagation ratio M²<2, in particular M²<1.7, and the second laser beam with a beam propagation ratio M²>2 or M²>1.7. In other words, the first laser beam can be guided in the light guide in at least almost diffraction-limited manner or almost at the diffraction limit, and the second laser beam can be guided in non-diffraction-limited manner, i.e., further away from the diffraction limit. This can be achieved, for example, by appropriate materials for light-guiding areas, i.e., core light-guiding areas, and the cladding areas surrounding them and/or the diameter of the light-guiding area(s)—optionally depending on the wavelength(s) used for the laser beams. For example, the first laser beam can be considered a pure single-mode laser beam at M²<1.3 and a quasi-single-mode laser beam at M²<1.5. The different beam propagation ratios M² and the corresponding beam qualities for the two laser beams proposed here have proven useful in practice. For example, even when both laser beams irradiate the optical device, it can be reliably achieved that only or at least primarily the first laser beam is influenced, i.e., its intensity distribution is changed, while the second laser beam can remain at least substantially unaffected.

In a further possible embodiment of the present invention, the light guide has an inner core or light guiding area for transporting the first laser beam and an outer core or light guiding area for transporting the second laser beam. The outer light guiding area surrounds the inner light guiding area in an annular manner, resulting in an intensity distribution of the second laser beam that surrounds the first laser beam in a correspondingly annular manner. This annular intensity distribution of the second laser beam here results from the annular or tubular shape of the outer light guiding area. The inner light guiding area, on the other hand, can, for example, be fully cylindrical in shape, i.e., take the form of a circular disk in cross-section. The inner light guiding area can in particular form the center of the light guide. In contrast, the outer light guiding area can surround the center, i.e., the central longitudinal axis of the light guide, coaxially or concentrically. Since the second laser beam can remain at least substantially unaffected by the optical device or can propagate past it, a ring-in-ring intensity distribution of the two laser beams with an inner ring and an outer ring surrounding it results downstream of the optical device. The inner ring of the intensity distribution is formed by the first laser beam and the outer ring of the intensity distribution concentrically surrounding said inner ring is formed by the second laser beam.

For this purpose, the light guide can be embodied, for example, as a “2-in-1” fiber or “n-in-1” fiber where n≥2 or as a “multiclad” fiber or can comprise such optical fibers. In this case, a cladding material or cladding area can be arranged in the radial direction between the inner light guiding area and the outer light guiding area in the cross-sectional plane perpendicular to the light propagation direction or to the longitudinal direction of the beam path or to the beam propagation direction of the laser beams. Likewise, the outer light guiding area can be surrounded by such a cladding material or cladding area. This embodiment prevents unwanted coupling of the two laser beams. This can, for example, prevent the central or deeper area of the cutting gap from being influenced by the second laser beam. This in turn can enable particularly simple adjustment or implementation of the desired influence on the respective workpiece or material in the respective use case. For example, the intensity or power or power density in the center of the cutting gap can be adjusted or adapted merely by appropriate adaptation of the first laser beam—and thus particularly easily.

By means of a cladding area, i.e., cladding around the inner or first light guiding area provided for guiding the first laser beam, overspill of photons of the first laser beam into the surrounding outer or second light guiding area provided for guiding the second laser beam can be avoided or at least reduced in comparison to a structure without such cladding between the light guiding areas. This enables a correspondingly higher power density of the first laser beam and better control or adjustability of the power in the outer ring, primarily formed by the second laser beam, of the entire intensity distribution. This enables particularly flexible and diverse application of the optics according to embodiments of the invention or of the corresponding laser system.

However, a structure of the light guide with the inner or first light guiding area provided for guiding the first laser beam and the outer or second light guiding area surrounding the inner or first light guiding area and provided for guiding the second laser beam, but without cladding arranged between these light guiding areas, can also be used. The light guiding areas can thus then, for example, be directly adjacent to one another. In this case, the outer or second light guiding area might not have to be exposed to laser light separately on the input side. This may optionally enable a simpler design of a corresponding laser system and represent a practical approach, for example, for laser cutting of components or materials in combination with hot forming.

In a further possible embodiment of the present invention, the optics have at least one focusing device for focusing the laser beams into a focus point or focus area located outside the optics on the output side. This focusing device is arranged in the beam path downstream of the light guide, when viewed in the longitudinal direction of the beam path or in the beam propagation direction of the laser beams. In particular, the focusing device can be embodied such that it is irradiated by both the first laser beam and the second laser beam. The focusing device can, for example, be or comprise a focusing lens. The focusing device can therefore be a single focusing element or can be embodied as multi-part partial optics of the optics according to embodiments of the invention, i.e., optionally comprising a plurality of optical elements. In particular, the focusing device can be configured or designed to generate a focus diameter of at most 600 μm, preferably of at most 300 μm, for the first laser beam. The focusing device, for example, enables particularly effective and efficient laser cutting. The focus diameters proposed here can be used to achieve flow-dynamic adaptation and optimization of the cutting gap geometry.

In a possible further embodiment of the present invention, the optical device, i.e., the element or the assembly for generating the annular intensity distribution of the first laser beam, is arranged, when viewed in the beam propagation direction thereof, i.e., along the beam path, between at least a part of the focusing device and the focus point or focus area. The arrangement of the optical device proposed here can enable a particularly simple structure for the optics. For example, the focusing device or any collimation device or collimation lens provided can be arranged particularly close to the output or end of the light guide. This makes it easy to avoid unnecessarily large expansion of the laser beams. The optical device does not necessarily have to be arranged in the 2f plane of the focusing device, i.e., at a distance therefrom corresponding to twice the focal length. This also enables a particularly flexible arrangement of the optical device, or an arrangement adapted to the respective installation space conditions in the respective use case, and thus a correspondingly flexible structure of the optics as a whole.

In a possible further embodiment of the present invention, the optics have a protective glass arranged on the output side in the beam path. This protective glass can therefore be arranged downstream of the focusing device, in particular when viewed along the beam propagation direction of the laser beams, i.e., along the longitudinal direction of the beam path, but upstream of the focus area located outside the optics. Such a protective glass can, for example, prevent or minimize the ingress of dust or dirt into the optics. Furthermore, it is provided here that the optical device for generating the annular intensity distribution of the first laser beam is arranged on this protective glass or is formed in this protective glass. In the former case, the protective glass can, for example, act as a holder or support for the optical device. In the latter case, the optical device can be formed, for example, by appropriate shaping or machining of the protective glass, in particular of its surface. In both cases it is possible, for example, to eliminate an additional holder for the optical device and to obtain particularly robust and permanently reliable positioning of the optical device.

In another possible embodiment of the present invention, the optical device for generating the annular intensity distribution of the first laser beam is arranged at a longitudinal position along the beam path at which at least the first laser beam has its largest diameter. This refers at least to the area of the optics according to embodiments of the invention, i.e., for example the area from the light guide to the focus point or focus area located outside the optics on the output side. Since the power of the first laser beam is predetermined, the surface energy density of the first laser beam is lowest at the point with the largest diameter. By arranging the optical device at this point along the beam path, each surface element of the optical device is thus exposed to as little intensity or power of the first laser beam as possible. This allows the corresponding load on the optical device to be minimized, for example to avoid damage or to increase its service life. For example, the optical device can be arranged here, when viewed along the beam path, on the side of the focusing device mentioned elsewhere that faces the light guide, in particular between said focusing device and the collimating device mentioned elsewhere.

In another possible embodiment of the present invention, the optics have an end element arranged directly at an output-side end of the light guide. This end element can thus, for example, be slipped or spliced or the like onto the output-side end of the light guide. For example, the end element may be a fiber end connector if the light guide is an optical fiber. Furthermore, it is provided here that the optical device for generating the annular intensity distribution of the first laser beam is arranged or formed in this end element. Likewise, the end element can be an output-side end region of the light guide. In this case, the optical device can, for example, be formed directly on or in the output-side end, i.e., the corresponding end face of the light guide. By means of the embodiment of the present invention proposed here, it can easily be achieved that the first laser beam and the second laser beam are already precisely and consistently arranged relative to one another or superimposed on one another at the point of entry into the optical device. This may make it possible to dispense with any corresponding additional beam shaping or beam guidance. In addition, it can be achieved that at least the first laser beam always, i.e., for example, even in the event of vibrations or the like, irradiates the optical device in the same way, for example in the same area and in the same direction. This enables the achievement of a permanently consistent, i.e., constant, intensity distribution and thus particularly high consistency and reliability of the properties of the optics or of the laser system equipped therewith. The end element can, for example, have an extent of up to several centimeters in the longitudinal direction or in the beam propagation direction.

In a possible further embodiment of the present invention, the end element comprises a machined end region of the light guide. The optical device is then formed by a height profile formed on the output-side end face, through which the laser light thus passes in the longitudinal direction or the beam propagation direction during operation. Such a height profile can, for example, be etched onto or into the end face of the light guide or produced by selective material removal, for example by means of a laser lithographic process or the like. Due to the further embodiment of the present invention proposed here, the optics can be constructed from particularly few components and can be particularly robust. For example, any relative movement between the light guide and the optical device can be eliminated in this way. This enables particularly robust and permanently consistent output-side beam properties to be achieved. Depending on the size and embodiment of the light guide and the available manufacturing processes, the height profile forming the optical device can be formed over the entire end face of the light guide or only in the area of the light guiding area transporting the first laser beam. The former variant can be particularly easy to manufacture, while the latter variant can completely avoid any influence of the second laser beam by the optical device.

According to a further possible embodiment of the present invention, the optical device is or comprises a spiral phase plate. Such a spiral phase plate can impose a phase singularity on the first laser beam. An annular intensity profile generated by such a spiral phase plate can propagate, i.e., be maintained, over a particularly long length or path in the beam propagation direction or in the longitudinal direction of the beam path, particularly for laser beams with a beam propagation ratio M²<1.5. This means that exposure to a correspondingly uniform intensity can be achieved within the cutting gap, even with particularly thick material of the workpiece to be cut. Likewise, a particularly large distance can be selected between the optics and the workpiece or material to be cut or machined without negatively influencing the cutting or machining result. This can enable correspondingly simple and safe relative positioning between the optics or laser system and the workpiece or material as well as particularly effective and efficient removal of molten or evaporated material toward the side. The use of a spiral phase plate for or as the optical device can enable particularly easy adaptation to different requirements or use cases. For example, the number of 2π phase jumps, i.e., the “topological charge”, and/or the number of height steps and/or the modulation depth of the spiral phase plate can be varied. For example, for practical applications, an amount of topological charge m can be selected in the range from 1 to 50, in particular in the range from 1 to 5. In particular, the amount of topological charge can be selected or set to be smaller than the largest azimuthal mode order of the second laser beam. This ensures that the second laser beam is not or not significantly influenced by the optical device, i.e., in this case the spiral phase plate.

In a possible further embodiment of the present invention, the spiral phase plate has at least 16 steps, i.e., height steps or different height levels, in particular at least 32 or at least 64 steps. This is based on the realization that although in principle fewer steps can be used for the spiral phase plate, for example 4 or 8 steps or the like, a larger number of stages enables greater efficiency. For example, with at least 32 steps, an efficiency of at least 97% can be achieved.

In a further possible embodiment of the present invention, the optical device is or comprises an S-waveplate. This can in particular be or comprise a component or material with location-dependent birefringence properties. This allows a polarization singularity to be imposed on the first laser beam, for example by forming a radial or azimuthal polarization or a mixed state thereof. For example, an S-waveplate can convert a linear polarization into a radial or azimuthal polarization or convert a circular polarization into an optical vortex, i.e., an annular intensity distribution. With such an S-waveplate, particularly favorable propagation properties for the intensity distribution of the first laser beam can be achieved. In addition, the S-waveplate has no or only a marginal or negligible influence on the second laser beam. Likewise, a segmented polarization converter or a geometric phase hologram (GPH) can be used as the optical device or as part thereof.

Embodiments of the present invention also relate to a laser system which can be configured in particular for laser cutting. The laser system according to embodiments of the invention has at least one laser source, the optics according to the invention and a coupling device for coupling various laser light components or laser beams into the light guide of the optics. The laser system according to the invention can in particular be the laser system mentioned in connection with the optics according to the invention or correspond thereto. The laser system, according to embodiments of the invention, can also have further components. For example, the laser system may comprise a power distribution device for adjusting a power distribution or a power ratio between the first laser beam and the second laser beam. This can in particular be configured for continuous adjustment of the power or the power component of the first laser beam and/or the second laser beam in each case between 0% and 100% of the respectively available power. Likewise, the laser system can, for example, have a control device, in particular a closed control loop, with which the power of the first laser beam and/or the second laser beam can be automatically controlled, for example as a function of the feed rate with which the optics or the focus area is moved relative to the workpiece or material to be machined. Likewise, the laser system can, for example, have a cutting or process gas system for generating and guiding, coaxially to the laser beams, a cutting or process gas stream, the flow direction of which corresponds to the propagation direction, i.e., the light propagation direction of the laser beams. Such a process gas system can, for example, comprise a control unit for controlling and stabilizing a gas pressure of the cutting or process gas and/or a gas nozzle and/or the like. For example, the gas nozzle can surround the laser beams downstream of the optics when viewed in the propagation direction. Likewise, the laser system can have a distance sensor for monitoring a distance between the workpiece or material in each case to be machined and a predefined reference point that is fixed in position relative to the laser system, for example a specific component or component point of the laser system, such as the gas nozzle. This can be coupled, for example, to a control device or a controlled drive in order to guide or hold the laser system or the respective reference point or the respective component, i.e., for example the gas nozzle or the optics, at a specified distance from the respective workpiece or material. Likewise, the laser system can have a drive or an adjustment device for generating relative movement between the laser system, in particular the optics, and the workpiece or material in each case to be cut or machined.

In one possible embodiment of the present invention, the laser system is configured to generate different wavelengths and/or different polarization states of the first laser beam and the second laser beam. In other words, the first laser beam and the second laser beam can thus have different wavelengths and/or polarization states during operation of the laser system. The use of different wavelengths can enable the use of maximum absorption conditions or adaptation to maximum absorption conditions taking into account the different primary beam incidence conditions of the two laser beams on the respective workpiece. For instance, the first laser beam can be incident primarily in a grazing manner, for example at an angle of between 70° and about 87°. The second laser beam, on the other hand, can be incident primarily orthogonally, i.e., for example at an angle of between 0° and 45°. For maximum absorption under the primary grazing beam incidence conditions of the first laser beam, a wavelength in the near infrared may, for example, be particularly favorable. For maximum absorption under the primary orthogonal beam incidence conditions of the second laser beam, on the other hand, a wavelength in the visible range may be particularly favorable. For example, a wavelength in the range from 0.8 μm to 2.1 μm can be used for the first laser beam. For the second laser beam, for example, a wavelength in the range from 0.2 μm to 0.8 μm can be used.

Depending on the embodiment and use case, different polarization states can be used for the two laser beams, for example circular or azimuthal or radial or stochastically distributed polarization states or combinations thereof. By selecting or using suitable polarization states, i.e., those adapted to the respective conditions or the respective use case, absorption efficiency or energy efficiency can be increased. Likewise, by adapting the polarization states, influence can be purposefully exerted on a resulting temperature profile of the absorption front. Thus, appropriate adaptation or adjustability of the laser system offers corresponding flexibility or adaptability to different situations and use cases.

Embodiments of present invention also relate to a method for operating a laser system according to embodiments of the present invention for machining, in particular for cutting, a workpiece or material. In the method, laser light is generated by means of at least one laser source. Furthermore, a first component of the laser light is transported as a single-mode or quasi-single-mode laser beam and a second component of the laser light is transported as a multi-mode laser beam with an annular intensity distribution in the light guide to the optics. At least the single-mode or quasi-single-mode laser beam irradiates the optical device, thereby generating a coaxial or concentric ring-in-ring intensity distribution, in which the annular intensity distribution of the single-mode or quasi-single-mode laser beam generated by the optical device is surrounded in an annular manner by the larger annular intensity distribution, coaxial thereto, of the multi-mode laser beam. In the method, the two laser beams are focused onto the workpiece to be machined, in particular cut, and the workpiece is machined, in particular cut, by means of the ring-in-ring intensity distribution. In this case, the optical device between the laser source and the workpiece-side focus of the laser beams is thus irradiated at least by the first laser beam. To machine or cut the workpiece, relative movement can be generated between the focus of the laser beams and the respective workpiece, i.e., the focus of the laser beams can effectively be guided over the workpiece, for example along a path specified in the respective use case.

Further embodiments of the invention are revealed by the following description of the figures and with reference to the drawings. The features and combinations of features mentioned above in the description as well as the features and combinations of features revealed below in the description of the figures and/or in the figures alone can be used not only in the combination indicated in each case, but also in other combinations or on their own.

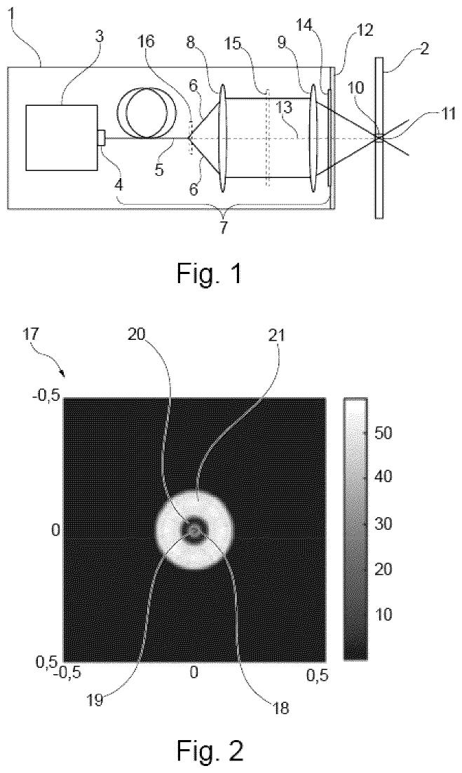

FIG. 1 shows a partially schematic view illustrating laser cutting using a laser system 1. This allows a schematically indicated workpiece 2 to be cut or machined, by way of example. The laser system 1 comprises at least one beam or laser source 3. Downstream of this laser source 3 is a coupling device 4 for coupling laser beams generated by the laser source 3 into a light guide 5 of the laser system 1, likewise indicated schematically here. The light guide 5 can, for example, be an optical fiber. This can in particular be a 2-in-1 fiber with an inner light guiding area and an outer light guiding area surrounding it.

Laser light 6, indicated schematically here, can emerge from the light guide 5 at an output-side end, i.e., at the opposite end from the coupling device 4 when viewed along the direction of light propagation. In order to be able to machine the workpiece 2 effectively, the laser system 1 here also comprises further optical elements or devices arranged downstream of the light guide 5. These can be referred to here together with the light guide 5 as optics 7. In particular, the optics 7 comprise a collimation device, which is indicated here in the form of a collimation lens 8. Furthermore, the optics 7 comprise a focusing device arranged downstream of the collimation lens 8 and indicated here as a focusing lens 9. The laser light 6 can first be collimated by means of the collimation lens 8. By means of the focusing lens 9, the collimated laser light 6 can then be focused into a focus area 10 located outside of the laser system 1. In this focus area 10, the maximum intensity or energy density of the laser light 6 can thus be achieved and a cutting gap 11 can thereby be created in the workpiece 2. The optics 7 can be embodied as transmission optics, as indicated here, but also entirely or in part as reflective optics.

For safety reasons and to protect the components, the laser system 1 can have, for example, a protective glass 12 on the output side, which can be irradiated by the laser light 6. Depending on the embodiment, the protective glass 12 can, for example, be arranged downstream of the optics 7 or be part of the optics 7.

Depending on the requirements or use case, the laser system 1 or the laser source 3 thereof can be differently embodied, for example as a CO₂ laser, or as a solid-state laser, such as a disk laser, fiber laser, diode laser, or the like. For typical laser cutting applications, the laser system 1 or the laser source 3 can, for example, have a laser power, in particular a continuous wave power, in the range of several kilowatts. This allows, for example, 3D sheets with a thickness of several millimeters to be cut. However, other applications or powers may also be possible.

In order to be able to produce not just a point-shaped bore in the workpiece 2, but rather the longitudinally extended cutting gap 11, an adjustment or displacement device (not explicitly shown here for the sake of clarity) can be used to produce a relative movement between the focus area 10 and the workpiece 2. This can be used, for example, to move the workpiece 2. Additionally or alternatively, the laser system 1 or the optics 7 thereof can be moved, tilted or adjusted thereby.

In addition, the laser system 1 may comprise a cutting or process gas system (also not explicitly shown here for the sake of clarity). This allows a cutting or process gas stream to be directed onto the cutting gap 11. In particular, this cutting or process gas stream can be guided coaxially relative to an optical axis 13, indicated schematically here, of the optics 7. This optical axis 13 corresponds here to the longitudinal direction of the beam path, i.e., the primary light or beam propagation direction of the laser light 6—at least after leaving the light guide 5. For this purpose, for example, a gas nozzle can be arranged on the outside of the laser system 1, which can surround the laser light 6 emerging through the protective glass 12. The flow direction of the cutting or process gas stream can therefore correspond to the primary propagation direction of the laser light 6.

The laser system 1 is configured here to achieve or enable a particularly high quality of the cutting gap 11 while at the same time achieving particularly good cutting performance. For this purpose, a ring-in-ring form of the laser light 6 is generated or used at least in the focus area 10. FIG. 2 shows a corresponding simulated ring-in-ring intensity distribution 17 in a cross-sectional plane perpendicular to the optical axis 13. For better understanding, an intensity scale is also shown here. The intensity distribution 17 here comprises an inner ring 18 with a central intensity minimum 19, which can be located in particular on the optical axis 13 or in the center of the cutting gap 11. The inner ring 18 is surrounded by an annular intensity minimum 20. Outside of this, there is an outer ring 21. The inner ring 18 and the outer ring 21 are therefore areas in which the laser light 6 propagates.

A component of the laser light 6 ultimately forming the inner ring 18 can be guided in the inner light guiding area of the light guide 5, while the component of the laser light 6 ultimately forming the outer ring 21 can be guided in the outer light guiding area of the light guide 5. The component of the laser light forming the inner ring 18, which is also referred to here as the first laser beam, can be guided in a diffraction-limited manner or at least relatively close or closer to the diffraction limit, for example as a single-mode or quasi-single-mode laser beam with a beam propagation ratio of M²<1.5. The first laser beam can therefore be guided in the light guide 5 at least primarily in the Gaussian or Gaussian-like basic mode. The component of the laser light 6 forming the outer ring 21, which is also referred to here as the second laser beam, can, on the other hand, be guided as a multi-mode laser beam in the light guide 5. In this case, the outer light guiding area of the light guide 5 can already have an annular shape, readily directly resulting in the outer ring 21. The second laser beam can be guided in the light guide 5 in a non-diffraction-limited manner, i.e., further away from the diffraction limit than the first laser beam, in particular with a beam propagation ratio of M²>1.5.

By means of the coupling device 4, corresponding modes can be selectively excited or coupled. In particular, different power components can be variably set for the inner ring 18 and the outer ring 21, i.e., for example, different power components can accordingly be coupled into the inner light guiding area and the outer light guiding area of the light guide 5. Power components of 0% to 100% are possible. However, during regular operation of the laser system 1, power components of more than 0% can be provided for both the inner ring 18 and the outer ring 21, i.e., for example, both the inner light guiding area and the outer light guiding area can be supplied with power, i.e., laser light 6 generated by the laser source 3, at the same time.

In order to shape the first laser beam into the inner ring 18, the laser system 1 has a singularity element 14. This allows a phase singularity or a polarization singularity to be imposed on the first laser beam. For this purpose, the singularity element 14 can be embodied, for example, as a spiral phase plate or as an S-waveplate. As indicated in FIG. 1, the singularity element 14 can be arranged or formed, for example, on the inside of the protective glass 12. However, other arrangements are also possible, which are indicated here as a first alternative position 15 between the collimation lens 8 and the focusing lens 9 and as a second alternative position 16 at the output-side end of the light guide 5 or between this and the collimation lens 8.

The singularity element 14 thus allows the first laser beam to be shaped into the inner ring 18, while the second laser beam can remain at least substantially unaffected. This results in the ring-in-ring intensity distribution 17, which can be maintained in the focus area 10 in the direction along the optical axis 13 for example over at least two Rayleigh lengths, i.e., for example, over several millimeters. This intensity distribution 17 can thus be present in particular at least over a large part of the thickness or material thickness of the workpiece 2.

Depending on the use case, the laser system, in particular the properties of the laser light 6 or the intensity distribution 17, can be adapted or adjusted as required. For example, a fiber laser can be used with an average power of about 3 kW at a wavelength of about 1070 nm. For the optics 7, for example, a collimation lens 8 with a focal length of f=200 mm and a focusing lens 9 with a focal length of f=300 mm can be used. By selecting a focus diameter suitable for the respective use case, flow-dynamic adaptation and optimization of the final cutting gap geometry can be achieved. It is, for example, possible to set in the focus area 10 a diameter ratio between the first laser beam and the second laser beam, i.e., the ratio of the diameter of the inner ring 18 to the diameter of the outer ring 21, of at most 1:8, preferably of at most 1:4. For example, in the focus area 10 for the first laser beam, i.e., for the inner ring 18, a diameter of at most 600 μm, in particular at most 150 μm, can be set.

With regard to power, for example, a power distribution or power ratio between the inner ring 18 and the outer ring 21 of approximately 2:1 can be set. Likewise, however, by way of example up to 95% of the total available laser power can be guided in the inner ring 18. The larger proportion of the laser power in the inner ring 18 can enable particularly effective and rapid melting or evaporation of the material of the workpiece 2. The smaller proportion of the laser power in the outer ring 21, on the other hand, may be sufficient to produce a radius, i.e., a rounding, at an end of the cutting gap 11 facing the laser system 1. This allows the cutting or process gas to reach the cutting gap 11 particularly effectively and efficiently. This ultimately makes it possible to achieve a particularly smooth, i.e., burr-free cutting edge, thus a particularly high quality cutting gap 11. This applies both to relatively low and relatively high feed powers or feed rates.

Likewise, suitable, in particular different, polarization states can be selected or set for the inner ring 18 and the outer ring 21. This can enable optimization of absorption efficiency or energy efficiency during laser cutting by means of the laser system 1 as well as influencing a temperature profile of the absorption front or of the workpiece 2 in the region of the cutting gap 11. In particular, when using a spiral phase plate as the singularity element 14, the first laser beam, i.e., the inner ring 18, can, for example, be linearly polarized, while the second laser beam, i.e., the outer ring 21, can be unpolarized. In particular when using an S-waveplate, the first laser beam, i.e., the inner ring 18, can, for example, be radially or azimuthally polarized, while the second laser beam, i.e., the outer ring 21, can be unpolarized.

Overall, the described examples show how a ring-in-ring beam profile can be obtained for laser applications and used to achieve improved cutting or machining results.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser system
2 Workpiece
3 Laser source
4 Coupling device
5 Light guide
6 Laser light
7 Optics
8 Collimation lens
9 Focusing lens
10 Focus area
11 Cutting gap
12 Protective glass
13 Optical axis
14 Singularity element
15 First alternative position
16 Second alternative position
17 Intensity distribution
18 Inner ring
19 Central intensity minimum
20 Annular intensity minimum
21 Outer ring

1. An optical system for laser cutting, the optical system comprising:
a light guide for simultaneously coaxially transporting a first laser beam as a single-mode or quasi-single-mode laser beam and a second laser beam as a multi-mode laser beam, and
an optical device arranged in a beam path of the first laser beam downstream of the light guide, wherein the optical device is configured to impose a phase singularity and/or a polarization singularity on the first laser beam for generating an annular intensity distribution of the first laser beam with a central intensity minimum on an optical axis of the optical system.

2. The optical system according to claim 1, wherein the light guide is configured to guide the first laser beam with a beam propagation ratio M² <2, and to guide the second laser beam with a beam propagation ratio M²>2.

3. The optical system according to claim 1, wherein the light guide comprises an inner light guiding area for transporting the first laser beam and an outer light guiding area annularly surrounding the inner light guiding area for transporting the second laser beam, such that an intensity distribution of the second laser beam annularly surrounding the first laser beam is obtained.

4. The optical system according to claim 1, further comprising:
a focusing device arranged in the beam path downstream of the light guide, wherein the focusing device is configured to focus the first laser beam and the second laser beam into a focus area located outside the optical system on an output side.

5. The optical system according to claim 4, wherein the focusing device is configured to produce a focus diameter of at most 600 μm for the first laser beam.

6. The optical system according to claim 4, wherein the optical device is arranged between the focusing device and the focus area when viewed in a beam propagation direction.

7. The optical system according to claim 6, further comprising:
a protective glass arranged on the output side in the beam path, wherein the optical device is arranged on the protective glass or formed in the protective glass.

8. The optical system according to claim 1, wherein the optical device is arranged at a longitudinal position along the beam path at which at least the first laser beam has a greatest diameter.

9. The optical system according to claim 1, further comprising:
an end element arranged directly at an output-side end of the light guide, wherein the optical device is arranged in the end element.

10. The optical system according to claim 9, wherein the end element comprises a machined end region of the light guide, and the optical device is formed by a height profile formed on the output-side end of the light guide.

11. The optical system according to claim 1, wherein the optical device comprises a spiral phase plate.

12. The optical system according to claim 11, wherein the spiral phase plate comprises at least 16 steps.

13. The optical system according to claim 1, wherein the optical device comprises an S-waveplate.

14. A laser system comprising:
an optical system according to claim 1,
at least one laser source for providing the first laser beam and the second laser beam, and
a coupling device for coupling the first laser beam and the second laser beam into the light guide of the of the optical system.

15. The laser system according to claim 14, wherein the laser system is configured to generate different wavelengths and/or different polarization states of the first laser beam and the second laser beam.

16. A method for operating a laser system according to claim 14 for machining a workpiece, the method comprising:
generating laser light by using the at least one laser source,
transporting a first component of the laser light as a single-mode or quasi-single-mode laser beam and a second component of the laser light as a multi-mode laser beam with an annular intensity distribution in the light guide to the optical system,
irradiating at least the single-mode or quasi-single-mode laser beam on the optical device, thereby generating a concentric ring-in-ring intensity distribution, wherein the annular intensity distribution of the single-mode or quasi-single-mode laser beam generated by the optical device is surrounded in an annular manner by a larger annular intensity distribution of the multi-mode laser beam, and
focusing the single-mode or quasi-single-mode laser beam and the multi-mode laser beam onto the workpiece, thereby machining the workpiece.
